(19) United States
(12) Patent Application Publication
(10) Pub. No.: US 2010/0172027 A1
(43) Pub. Date: Jul. 8, 2010

(54) OPTICAL MEMBER

(76) Inventors: Kazuhiro Yamada, Osaka (JP); Yasuhiro Tanaka, Hyogo (JP); Michihiro Yamagata, Osaka (JP); Katsuhiko Hayashi, Osaka (JP); Kazuhlko Ishimaru, Osaka (JP); Motonobu Yoshikawa, Osaka (JP)

Correspondence Address: MARK D. SARALINO (PAN);RENNER, OTTO, BOISSELLE & SKLAR, LLP, 1621 EUCLID AVENUE, 19TH FLOOR, CLEVELAND, OH, 44115, US

(21) Appl. No.: 12/303,594

(22) PCT Filed: Jun. 4, 2007
(86) PCT No.: PCT/JP2007/061283

§ 371 Date: Dec. 5, 2008

(30) Foreign Application Priority Data
Jun. 6, 2006 (JP) 2006-157507

(51) Int. Cl. G02B 1/11

(52) U.S. Cl. 359/601

(57) ABSTRACT

The present invention relates to an optical element and, more particularly relates to an optical element having at least one surface in which an antireflection concave-convex structure is formed.

The present invention provides an optical member in which the generation of diffraction light and reflection is sufficiently suppressed and which has a structure that can be formed in a simple manner.

On a first lens surface (10) of a lens 1, an antireflection concave-convex structure (11) including a plurality of cone convex portions (12) regularly arranged is formed. The antireflection concave-convex structure (11) is for suppressing reflection of light having a wavelength equal to or larger than a cycle of the cone convex portions (12). The antireflection concave-convex structure (11) is formed so that the cycle and/or a height of the structure units differ among regions of the first surface (10).

### TECHNICAL FIELD

The present disclosure relates to an optical member and, more particularly relates to an optical member having at least one surface in which an antireflection concave-convex structure is formed.

### BACKGROUND ART

In recent years, there have been proposed various kinds of optical elements in which antireflection processing for suppressing reflection of light is performed to a surface. As antireflection processing, for example, processing in which an antireflection film is formed of a film (low refractive index film) having a relatively low refractive index, a multilayer film including a low refractive index film and a film (high refractive index film) having a relatively high refractive index which are alternately stacked, or the like on a surface of an optical element (see, for example, Patent Document 1 and the like).

However, to form an antireflection film formed of a low refractive index film or a multilayer film, a complicated step such as vapor deposition, sputtering or the like has to be performed. Therefore, there arises a problem in which productivity is low and cost is high. Moreover, there is another problem in which an antireflection film formed of a low refractive index film or a multilayer film has large dependency on wavelength and incident angle.

In view of the above-described problems, as antireflection processing having relatively less dependency on incident angle and wavelength, for example, a processing in which a fine structure (for example, a fine structure including filiform concaves and filiform convexes regularly arranged, a fine structures including cone concaves and cone convexes regularly arranged, or the like and such fine structure will be hereinafter referred to an “antireflection concave-convex structure” occasionally) is formed on an optical element surface so that concaves/convexes are regularly formed with a pitch equal to or smaller than a wavelength of incident light has been proposed (see, for example, Non-Patent Documents 1, and the like). With the antireflection concave-convex structure formed on an optical element surface, abrupt change in refractive index at an element boundary surface can be suppressed and the refractive index is gradually changed at the element boundary surface. Accordingly, reflection at the optical element surface is reduced, so that a high rate of incidence of light coming into the optical element can be realized. Note that in Non-Patent Document 1, it is described that a cycle of a fine structure is preferably set to be 0.4 times or more and 1 times or less as large as the wavelength of light of which reflection is desired to be suppressed.
Patent Document 1: Japanese Laid-Open Publication No. 2001-127852
Non-Patent Document 1: Daniel H. Raguin and G. Michael Morris, Analysis of antireflection-structured surfaces with continuous one-dimensional surface profiles, Applied Optics, Vol. 32, No. 14, pp. 2582-2598, 1993
Non-Patent Document 2: Hiroshi Toyota, Nonreflective cyclical structure, Optical technology contact, Vol. 42, No. 3

### DISCLOSURE OF INVENTION

### Problems that the Invention is to Solve

Normally, reflection of light having a wavelength equal to or larger than a cycle of an antireflection concave-convex structure can be reduced using an antireflection concave-convex structure. However, because of factors such as a cycle of an antireflection concave-convex structure, refractive index and incident angle of light coming into an optical element and the like, even when light having a wavelength larger than the cycle of the antireflection concave-convex structure comes into the optical element, diffraction light might be generated. When diffraction light is generated, the diffraction light might become noise light and cause reduction in optical performance of the optical element, or an optical system or an optical device provided with the optical element. For example, there might be cases where when diffraction light is generated in an optical element constituting a pickup optical system (such as an optical disc optical system), the diffraction light comes into a detector and largely affects a servo signal and a reproduction signal. Therefore, it is preferable that an antireflection concave-convex structure having a small cycle which allows prevention of the generation of diffraction light is formed on an element surface.

According to Non-Patent Document 2, a reflectivity of light at an element surface on which an antireflection concave-convex structure is formed correlates with a height of the antireflection concave-convex structure. Specifically, as the height of the antireflection concave-convex structure is increased, the reflectivity is reduced. Therefore, in view of reducing a reflectivity at an element surface, an antireflection concave-convex structure is preferably formed on the element surface so as to have a large height.

That is, to sufficiently suppress reflection of light and also suppress the generation of diffraction light, an antireflection concave-convex structure is preferably formed on an element surface so as to have a small cycle and a large height (in other words, a large aspect ratio). However, there is a problem in which it is very difficult to form an antireflection concave-convex structure having a large aspect ratio. In other words, it is difficult to form an optical member such as an optical element and the like in which the generation of diffraction light and surface reflection are sufficiently suppressed.

In view of the above-described problems, the present invention has been devised and provides an optical member having a structure in which the generation of diffraction light and reflection are sufficiently suppressed and which can be fabricated in a simple manner.

### Solutions to the Problems

To achieve the above-described objectives, the present invention is directed to an optical member having at least one surface on which an antireflection concave-convex structure which includes a plurality of structure units regularly arranged and suppresses reflection of light having a wavelength equal to or larger than a cycle of the structure units, and is characterized in that the antireflection concave-convex structure is formed so that the cycle and/or a height of the structure units differ among regions of the surface.

### Advantages of the Invention

According to the present invention, an optical member having a structure in which reflection and generation of diffraction light are sufficiently suppressed and which can be fabricated in a simple manner can be realized.

### BRIEF DESCRIPTION OF DRAWINGS

FIG. 1 is a schematic diagram of a one-dimensional cyclic structure where incident light comes into.

FIG. 2 is a diagram showing the relationship between incident angle and diffraction angle.

FIG. 3 is a schematic cross-sectional view of a lens 1 according to Embodiment 1.

FIG. 4 is an enlarged view of part indicated by IV of FIG. 3.

FIG. 5 is a cross-sectional view of a black body 2 according to Embodiment 2.

FIG. 6 is a view illustrating an objective lens 3 according to an example.

FIG. 7 is a graph showing the correlation between light beam height (h) and cycle with which diffraction light is not generated.

### EXPLANATION OF REFERENCE NUMERALS

1 Lens

2 Black body

3 Objective lens

4 Optical disc

5 Information recording surface

10, 20 Lens surface

11, 21 and 31 Antireflection concave-convex structure

12, 22 and 32 Cone convex

30 Surface

### BEST MODE FOR CARRYING OUT THE INVENTION

An optical member according to this embodiment is an optical member in which an antireflection concave-convex structure in which a cycle and/or a height of a structural unit constituting the antireflection concave-convex structure are/is adjusted to allow a high optical performance and fabrication thereof in a simple manner. Hereinafter, specific structures according to embodiments of the present invention will be described in detail with reference to the accompanying drawings.

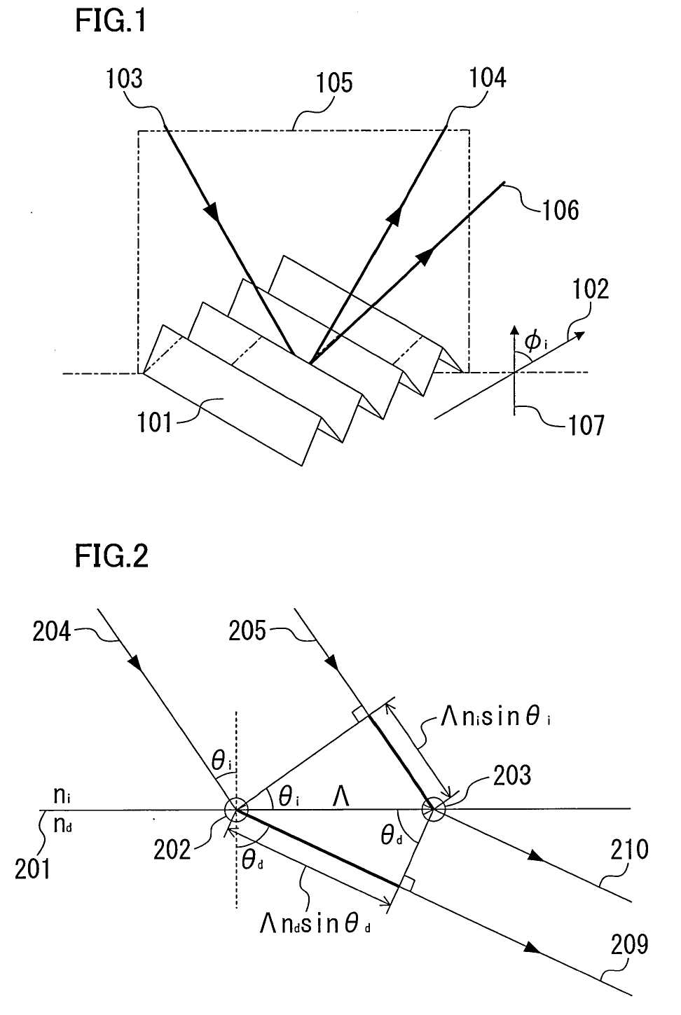

First, before describing embodiments of the present invention, a cycle of a structure unit for preventing the generation of diffraction light will be described with reference to FIGS. 1 and 2. Using, as an example, the case where as an antireflection concave-convex structure, a one-dimensional cyclic structure in which a plurality of filiform projections each having a triangular cross section are arranged is formed, the following description will be given.

FIG. 1 is a schematic diagram of a one-dimensional cyclic structure 101 in which a plurality of filiform projections each having a triangular cross section are arranged, when incident light comes into the one-dimensional periodic structure 101. In FIG. 1, 102 denotes a lattice vector of the one-dimensional cyclic structure 101. Also, 103 denotes incident light coming into the one-dimensional cyclic structure 101 and 104 denotes reflection light in the one-dimensional cyclic structure 101. Moreover, 105 denotes a light incident surface defined by the incident light 103 and outgoing light 104. 106 denotes diffraction light generated in the one-dimensional cyclic structure 101. An angle between a normal vector 107 and a lattice vector 102 of the incident light 105 is indicated by φᵢ. FIG. 2 is a diagram describing the relationship between incident light θᵢ and a diffraction angle θ_{d} when the angle φᵢ between the normal vector 107 and the lattice vector 102 is 90 degrees.

Assume that cyclic structures 202 and 203 (which will be hereinafter referred to as lattice points, respectively) are aligned along a boundary surface 201 with a cycle Λ, as shown in FIG. 2. In this case, across the boundary surface 201, nᵢ denotes a refractive index of light incidence side and n_{d} denotes a refractive index of light diffraction side. Assuming that an incident angle of collimated light beams 204 and 205 respectively toward the lattice points 202 and 203 is θᵢ, an optical path difference between the incident light beams 204 and 205 is Λnᵢsinθᵢ. Moreover, assuming that an output angle of diffraction light beams 209 and 210 is θ_{d}, an optical path difference between the diffraction light beams 209 and 210 is Λn·sin θ_{d}. When a difference between the optical path difference (Λnᵢ·sin θᵢ) between the light beams 204 and 205 and the optical path difference (Λn_{d}·sin θ_{d}) between the diffraction light beams 209 and 210 satisfies the condition that the difference is an integral multiple (m times) as large as a wavelength λ in vacuum, i.e., the difference satisfies the following Formula (1), m-dimensional diffraction lights 209 and 210 are generated.

[Formula 1]

Λ(n_{d} sin θhd d−nᵢ sin θᵢ)=mλ, (1)

The condition for diffraction light not to be generated at a maximum incident angle θₘₐₓ is that whatever value the angle θ_{d} takes, an absolute value in the left side of Formula (1) is less than the wavelength. That is, when Formula (2) below is satisfied, diffraction light is not generated even at the maximum angle θₘₐₓ.

It can be understood from Formula (2) that there is a tendency that as an incident angle is increased, the cycle Λ is reduced. There also a tendency that as a wavelength of incident light is reduced, the cycle Λ is reduced.

$$\begin{matrix}[ Formula 2 ] & \\ \frac{Λ}{λ} < \frac{1}{{n}_{d} + {n}_{i} sin {θ}_{max}} & ( 2 )\end{matrix}$$

### Embodiment 1

In Embodiment 1, as an example embodiment of an optical member according to the present invention, a lens 1 will be described.

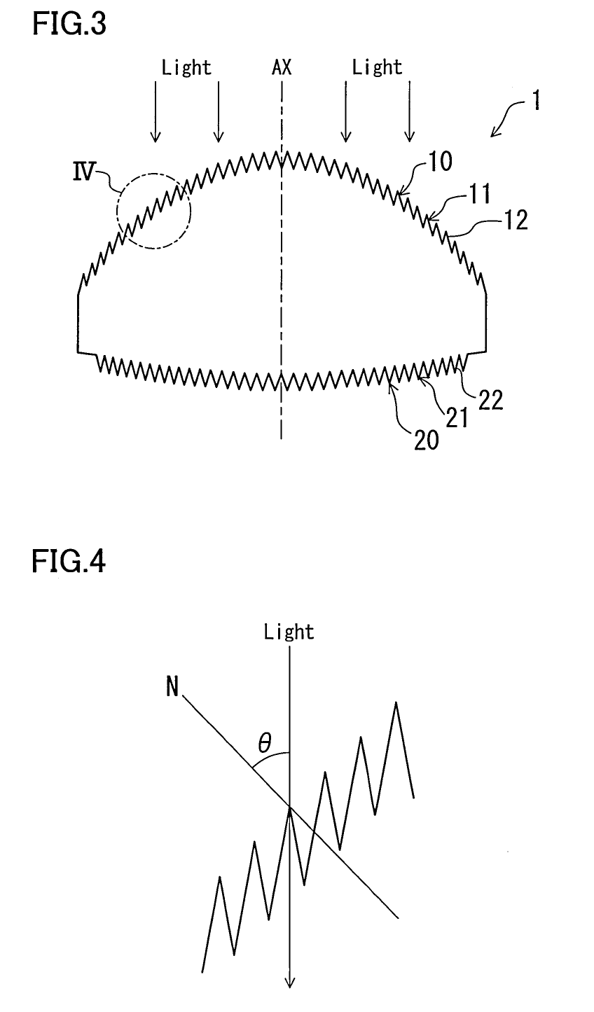

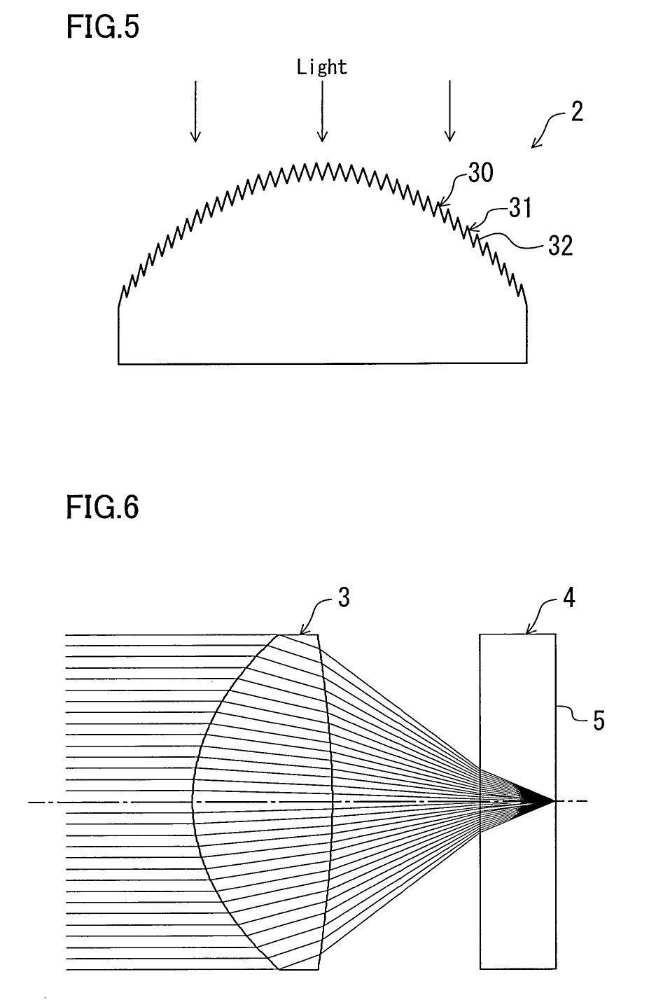

FIG. 3 is a schematic cross-sectional view of a lens 1 according to Embodiment 1. FIG. 4 is an enlarged view of part indicated by IV of FIG. 3. Note that in FIG. 3 (and also in FIG. 5), for the sake of explanation, an antireflection concave-convex structure 11 is illustrated larger than an actual scale size thereof.

The lens 1 of Embodiment 1 is formed so as to have a first lens surface 10 and a second lens surface 20 which are both curved surfaces (specifically, convex surfaces) so that light coming into the first lens surface 10 is output from the second lens surface 20. On the first lens surface 10, an antireflection concave-convex structure 11 in which a plurality of structure units (for example, concave-convex structure units) are regularly arranged is formed. Specifically, the antireflection concave-convex structure 11 is formed of cone convex portions 12 as structure units which are regularly arranged (for example, in matrix or in delta configuration). Note that a “cone” is herein a generic term for a circular conical shape, a pyramidal shape, a circular conical shape with its apex chamfered or R-chamfered, a pyramidal shape with its apex chamfered or R-chamfered, an oblique conical shape (i.e., oblique circular conical shape and oblique pyramidal shape) and an oblique conical shape with its apex chamfered or R-chamfered and includes a shape formed so that a generating line is a curved line and/or made of a plurality of line segments. Moreover, a “filiform convex portion” is a generic term for convex portions each of which extends like a thread and has a triangle, rectangular, polygonal, domal, semicircle, or semielliptical cross-section. A “filiform concave portion” is a general term for concave portions each of which extends like a thread and has a triangle, rectangular, polygonal, domal, semicircle, or semielliptical cross section.

Also, on the second lens surface 20, an antireflection concave-convex structure 21 in which a plurality of structure units are regularly arranged is formed. Specifically, the antireflection concave-convex structure 21 is formed of cone convex portions 22 as structure units which are regularly arranged. The antireflection concave-convex structures 11 and 12 are for preventing reflection of incident light and outgoing light at the lens surfaces 10 and 20. Thus, the lens 1 having a high transmissivity can be achieved by providing the antireflection concave-convex structures 11 and 21 on the lens surfaces 10 and 20.

In Embodiment 1, the antireflection concave-convex structure 11 is formed so that a cycle and/or a height of the cone convex portions 12 differ among regions of the first lens surface 10. Also, the antireflection concave-convex structure 21 is formed so that a cycle and/or a height of the cone convex portions 22 differ among regions of the second lens 20. Herein, a “cycle” means a distance between the closest two of the cone convex portions 12, when viewed from the top, i.e., from the side at which incident light comes in or the side at which outgoing light is output. A “height” herein means a distance from a base surface to an apex of a cone convex portion 12 along an optical axis direction. Hereinafter, advantages of use of the above-described structure will be described with the first lens surface 10 taken up as an example.

As in Example 1, for example, in the case where the first lens surface 10 is a curved surface and an angle of the first lens surface 10 at each point of the first lens surface 10 with respect to an optical axis changes depending on a distance of the point of the first lens surface 10 from the optical axis, an incident angle θ of a light beam on the first lens surface 10 (i.e., an angle between a normal line N and the light beam at a point) varies from point to point. For example, assume that the plurality of cone convex portions 12 having the same height are provided with a certain cycle in an entire region of the first lens surface 10 (specifically, in an entire optical effective region of the first lens surface 10). In order to sufficiently reduce an optical reflectivity at the entire first lens surface 10 and suppress the generation of diffraction light, the cone convex portions 12 have to be formed with a small cycle at which diffraction light is not generated even in a region of the first lens surface 10 in which the incident angle θ is maximum (i.e., in an edge region of the first lens surface 10 in Embodiment 1) so as to have an enough height to achieve a sufficient antireflection effect. That is, the cone convex portions 12 having a large aspect ratio have to be formed at the entire first lens. Therefore, it is very difficult to fabricate the lens 1.

In contrast, according to Embodiment 1, for example, it is possible to design the lens 1 so that the cone convex portions 12 having a large height are provided with a small cycle in a region (for example, an edge region of the first lens surface 10) in which the incident angle θ is large and the cone convex portions 12 having a small height are provided with a larger cycle in a region (a vicinity region to the optical axis) in which the incident angle θ is small. By designing the lens 1 in the above-described manner, fabrication simplicity in fabricating the lens 1 can be improved while the reflectivity is sufficiently reduced and the generation of diffraction light is suppressed in the entire region of the first lens surface 10.

In consideration of the degrees of fabrication simplicity, the diffraction light suppressive effect and the antireflection effect, the structure (including cycle and height) of the antireflection concave-convex structure 11 can be freely set as necessary. That is, the degree of design freedom of the lens 1 can be improved by forming the antireflection concave-convex structure 11 so that a cycle and/or a height of the cone convex portions 12 differ among regions of the first lens surface 10.

Note that as in Embodiment 1, when the incident angle θ is continuously changed depending on a distance between the first lens surface 10 and the optical axis, the antireflection concave-convex structure 11 may be formed so that the cycle and/or height of the cone convex portions 12 varies continuously or in a stepwise manner depending on the distance from the optical axis.

As another example, for example, in a pickup lens which is for use in a pickup optical system compatible to a plurality of optical information recording mediums such as a CD (compact disc), a DVD (digital versatile disc) and the like and have respective regions through which lights having respective wavelengths corresponding to types of the optical information recording mediums pass, respectively, cone convex portions 12 having a small height may be formed with a small cycle in a region through which light having a relatively small wavelength passes and, on the other hand, cone convex portions 12 having a large height may be formed with a large cycle in a region through which light having a relatively large wavelength passes. Thus, for all types of lights, reflectivity can be reduced and the generation of diffraction light can be suppressed, while fabrication simplicity of a pickup lens can be improved.

When the cycle of the cone convex portions 12 in the optical axis vicinity region is set to be relatively large and the cycle of the cone convex portions 12 in the edge region is set to be relatively small, the generation of diffraction light in the edge region in which the incident angle θ is large can be suppressed. Moreover, since the cycle of the cone convex portions 12 is relatively large in the optical axis vicinity region, the lens 1 can be fabricated in a simple manner and mechanical strength of the cone convex portions 12 in the optical axis vicinity region can be improved. Furthermore, when the height of the cone convex portions 12 in the optical axis vicinity region is set to be relatively small and the height of the cone convex portions 12 in the edge region is set to be relatively large, a sufficient antireflection effect can be achieved in the edge region. Since the aspect ratio (i.e., the ratio of the height to the cycle) of the cone convex portions 12 can be set to be small in the optical axis vicinity region, the strength of the cone convex portions 12 can be further improved. That is, the lens 1 exhibiting high mechanical resistance can be realized. On the other hand, when the height of the cone convex portions 12 in the optical axis vicinity region is set to be relatively large and the height of the cone convex portions 12 in the edge region is set to be relatively small to achieve a relatively uniform aspect ratio throughout the entire first lens surface 10, the mechanical resistance of the cone convex portions 12 in the edge region can be improved and a further increased antireflection effect in the optical axis vicinity region can be achieved as well as fabrication simplicity in fabricating the lens 1 can be improved.

In contrast, when the cycle of the cone convex portion 12 in the optical axis vicinity region is set to be relatively small and the cycle of the cone convex portion 12 in the edge region is set to be relatively large, the generation of diffraction light in the optical axis vicinity region can be further suppressed and shape accuracy for the cone convex portions 12 in the edge region can be improved. In other words, the cone convex portions 12 in the edge region, which are difficult to form with relatively high shape accuracy, can be formed with high shape accuracy and thus an optical performance in the edge region can be improved. Furthermore, when the height of the cone convex portions 12 in the optical axis vicinity region is set to be relatively small and the height of the cone convex portions 12 in the edge region is set to be relatively large, the aspect ratio can be uniformed throughout the entire first lens surface 10, so that fabrication simplicity in fabricating the lens 1 can be improved and the mechanical strength of the cone convex portions 12 in the optical axis vicinity region can be improved while an increased antireflection effect in the edge region can be achieved. On the other hand, when the height of the cone convex portions 12 in the optical axis vicinity region is set to be relatively large and the height of the cone convex portions 12 in the edge region is set to be relatively small, the shape accuracy of the cone convex portions 12 in the edge region can be improved. In other words, the cone convex portions 12 in the edge region, which are difficult to form with relatively high shape accuracy, can be formed with high shape accuracy and thus an optical performance in the edge region can be improved. Moreover, a reflectivity in the optical axis vicinity region can be further reduced.

When the height of the cone convex portions 12 in the optical axis vicinity region is set to be relatively small and the height of the cone convex portions 12 in the edge region is set to be relatively large while making a constant cycle for the cone convex portions 12 throughout the entire first lens surface 10, the reflectivity in the edge region in which the incident angle θ is relatively large can be effectively reduced and the mechanical strength of the cone convex portions 12 in the optical axis vicinity region in which the cone convex portions 12 are prone to be brought in contact with some other member can be improved.

On the other hand, when the height of cone convex portions 12 in the optical axis vicinity region is set to be relatively large and the height of the cone convex portions 12 in the edge region is set to be relatively small while making a constant cycle for the cone convex portions 12 throughout the entire first lens surface 10, the reflectivity of light in the optical axis vicinity region can be further reduced and shape accuracy for the cone convex portions 12 in the edge region can be improved. In other words, the cone convex portions 12 in the edge region, which are difficult to form with relatively high shape accuracy, can be formed with high shape accuracy and thus an optical performance can be improved.

As has been described, in Embodiment 1, the case where cone convex portions as structure units are formed has been described. However, a structure unit may be, for example, a cone concave portion, a filiform convex portion, a filiform concave portion or the like.

### Embodiment 2

FIG. 5 is a cross-sectional view of a black body 2 according to Embodiment 2.

In Embodiment 1, as an example embodiment of the present invention, the light transmissive lens 1 has been described. However, an optical member according to the present invention does not have to be light transmissive. For example, a black body formed of a light absorbing member or the like may be used. In Embodiment 2, taking up a black body 2 formed of a light absorbing member as an example, another embodiment of the present invention will be described.

The black body 2 of Embodiment 2 has a surface 30 on which an antireflection concave-convex structure 31 including cone convex portions 32 as structure units regularly arranged is formed. The antireflection concave-convex structure 31 is for preventing reflection of incident light and is formed so that incident light coming into the surface 30 of the black body 2 is absorbed by the black body 2 and reflection light is not substantially generated therein.

Also in Embodiment 2, in the same manner as the antireflection concave-convex structure 11 of Embodiment 1, the antireflection concave-convex structure 31 is formed so that a cycle and/or a height of the cone convex portions 32 differ among regions of the surface 30. Using this structure, as described in Embodiment 1, the degree of design freedom for the surface 30 can be improved.

For example, it is possible to design the antireflection concave-convex structure 31 so that cone convex portions 32 having a large height are provided with a small cycle in a region in which an incident angle θ is large and, on the other hand, cone convex portions 32 having a small height are provided with a large cycle in a region in which an incident angle θ is small. By designing in such manner, the generation of diffraction light can be suppressed and a reflectivity can be sufficiently reduced throughout the surface 30 while fabrication simplicity for fabricating the black body 2 can be improved.

### Examples

FIG. 6 is a view illustrating an objective lens 3 according to this example.

Table 1 below shows specific numeric data for the objective lens 3 of this example. In Table 1, surface numbers are assigned to surfaces in an ascending order from the optical source side. For example, a surface denoted by the surface number 1 is an optical source side surface of the objective lens 3 and a surface denoted by the surface number 2 is a surface of the objective lens 3 located in the optical disc 4 side. As a thickness, a distance between surfaces is indicated. As a refractive index, a refractive index of each lens material with respect to incident light (having a wavelength of 660 mm) is shown.

TABLE 1

| | Apex | | | | |
|---|---|---|---|---|---|
| Surface | curvature | Thick- | Refractive | Effective | |
| number | radius | ness | index | diameter | Remarks |
| 0 | ∞ | ∞ | | | |
| 1 | 1.35 | 1.1 | 1.540481 | 2.60000 | Aspheric |
| | | | | | surface * |
| 2 | −5.93868 | 1.155248 | | 2.53740 | Aspheric |
| | | | | | surface * |
| 3 | ∞ | 0.6 | 1.578152 | | |
| 4 | ∞ | | | | |

The objective lens 3 is for collecting collimated light beams to an information recording surface 5 of the optical disc 4. Each of lens surfaces of the objective lens 3 is an aspheric surface, which can be expressed by Formula (3) below.

$$\begin{matrix}[ Formula 3 ] & \\ X = \frac{\frac{1}{RD} {h}^{2}}{1 + \sqrt{1 - ( 1 + CC ) {( \frac{1}{RD} )}^{2} {h}^{2}}} + \sum {A}_{n} {h}^{n} & ( 3 )\end{matrix}$$

In Formula (3),
X is a distance (mm) between a point at an aspheric surface whose height from an optical axis is indicated by h and a tangent plane including an apex of the aspheric surface,
h is the height (mm) from the optical axis,
RD is a curvature radius (mm) at the apex of the aspheric surface,
CC is a conical coefficient, and
An is an n-dimensional aspheric surface coefficient.

Lens data for both lens surfaces of the objective lens are shown in Table 2 below.

TABLE 2

| Surface number | | 1 | 2 |
|---|---|---|---|
| Apex curvature radius | RD | 1.35 | −5.93868 |
| Conical coefficient | CC | −0.95492 | −0.9002 |
| Aspheric surface coefficient | A4 | 0.016325 | 0.013115 |
| | A6 | 0.000505 | −0.00193 |
| | A8 | −0.00017 | 0.000163 |

First, in the objective lens 3 described above, a cycle of an antireflection concave-convex structure in which diffraction light is not generated was calculated for a height of each light beam using Formula (2) below. Note that an incident angle of the light beam is obtained by light beam tracking

$$\begin{matrix}[ Formula 2 ] & \\ \frac{Λ}{λ} < \frac{1}{{n}_{d} + {n}_{i} sin {θ}_{max}} & ( 2 )\end{matrix}$$

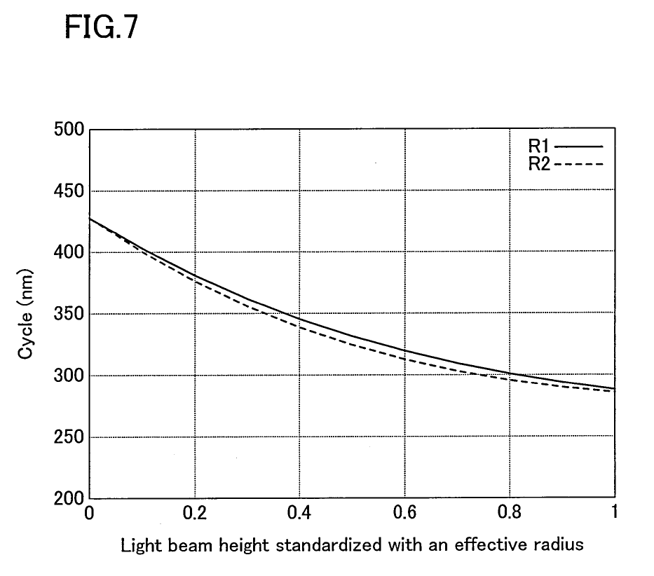

Table 3 below shows the relationship between the light beam height (h) and the longest cycle (nm) at which diffraction light is not generated at the light source side surface (which will be hereinafter referred to as a “first surface”) of the objective lens 3, which has been calculated. Table 4 below shows the relationship between the light beam height (h) and a cycle (nm) at which diffraction light is not generated at the optical disc side surface (which will be hereinafter referred to as a “second surface”) of the objective lens 3, which has been calculated. FIG. 7 is a graph showing the correlation between the light beam height (h) and the longest cycle at which diffraction light is not generated. In FIG. 7, data indicated by a solid line R1 is data for the first surface and data indicated by a dashed line R2 is data for the second surface. Note that in Table 3 and Table 4, the light beam height (h) is indicated by values standardized with an effective radius.

TABLE 3

| Light beam | Tilt of light | Tilt of | Incident | Cycle |
|---|---|---|---|---|
| height* | beam (°) | surface (°) | angle (°) | (nm) |
| 0.0 | 0.0 | 0.0 | 0.0 | 428.0 |
| 0.1 | 1.9 | 5.5 | 5.5 | 403.0 |
| 0.2 | 3.9 | 10.9 | 10.9 | 381.1 |
| 0.3 | 5.8 | 16.3 | 16.3 | 362.1 |
| 0.4 | 7.8 | 21.5 | 21.5 | 345.7 |
| 0.5 | 9.7 | 26.6 | 26.6 | 331.7 |
| 0.6 | 11.7 | 31.5 | 31.5 | 319.8 |
| 0.7 | 13.6 | 36.1 | 36.1 | 309.7 |
| 0.8 | 15.6 | 40.5 | 40.5 | 301.2 |
| 0.9 | 17.5 | 44.6 | 44.6 | 294.1 |
| 1.0 | 19.4 | 48.4 | 48.4 | 288.3 |

TABLE 4

| Light beam | Tilt of light | Tilt of | Incident | Cycle |
|---|---|---|---|---|
| height* | beam (°) | surface (°) | angle (°) | (nm) |
| 0.0 | 0.0 | 0.0 | 0.0 | 428.0 |
| 0.1 | 3.5 | 2.0 | 5.5 | 400.4 |
| 0.2 | 6.9 | 4.0 | 10.9 | 376.5 |
| 0.3 | 10.5 | 5.8 | 16.3 | 356.2 |
| 0.4 | 14.0 | 7.5 | 21.5 | 339.0 |
| 0.5 | 17.7 | 8.8 | 26.5 | 324.7 |
| 0.6 | 21.4 | 9.9 | 31.3 | 312.9 |
| 0.7 | 25.2 | 10.6 | 35.8 | 303.4 |
| 0.8 | 29.0 | 10.9 | 39.9 | 295.9 |
| 0.9 | 32.9 | 10.8 | 43.7 | 290.3 |
| 1.0 | 36.8 | 10.4 | 47.2 | 286.1 |

It has been understood from calculation results that the longest cycle (nm) at which the generation of diffraction light is suppressed in the optical axis vicinity region is about 1.5 times as long as that in the edge region.

Next, the height of cone convex portions was set to be ½ of a wavelength (660 nm) of an incident light beam and the transmissivity of the objective lens 3 in which the cone convex portions 12 were squarely arranged on the first surface and the second surface so that a cycle of the cone convex portions in each region matched the corresponding longest cycle calculated based on the above-described calculation results was obtained by computing simulation (RCWA). As a result, the transmissivity of the objective lens 3 was 96.2%, which was very high.

### INDUSTRIAL APPLICABILITY

An optical member according to the present invention has a high optical performance and can be fabricated in a simple manner. The inventive optical member is widely applicable to, in addition to an optical element such as a lens element, a prism element and a mirror element, which is required to have the antireflection effect, an optical device such as a screen, a lens tube, a shielding member, a fluorescence lamp and the like, a solar cell, and the like, and can be preferably applied to an optical pickup of an optical reproducing/recording system, an image shooting optical system of a digital still camera, projection system and illumination system of a projector, an optical scanning optical system, and the like in which the optical element or the optical device is provided.

1. An optical member having at least one surface on which an antireflection concave-convex structure which includes a plurality of structure units regularly arranged and suppresses reflection of light having a wavelength equal to or larger than a cycle of the structure units,
wherein the antireflection concave-convex structure is formed so that the cycle and/or height of the structure units differ among regions of the surface.

2. The optical member of claim 1, wherein the structure units are cone convex portions, cone concave portions, filiform convex portions or filiform concave portions.

3. The optical member of claim 1, wherein an angle of the surface with respect to an optical axis differs between the regions.

4. The optical member of claim 1, wherein the surface is a curved surface.

5. The optical member of claim 1, wherein light coming into the optical member through the surface is output from the optical member through another surface.

6. The optical member of claim 1, wherein the surface is formed in a concave shape or a convex shape and the antireflection concave-convex structure is formed on the surface so that the cycle and/or height of the structure units differ among an optical axis vicinity region of the surface and an edge region of the surface located closer to an edge of the surface.

7. The optical member of claim 1, wherein an angle of the surface with respect to the optical axis changes in a step wise manner or continuously depending on a distance of a point of the surface from the optical axis and the antireflection concave-convex structure is formed on the surface so that the cycle and/or height of the structure units varies in a correlation with the angle between the surface and the optical axis.
